(19) United States
(12) Patent Application Publication
(10) Pub. No.: US 2012/0224905 A1
(43) Pub. Date: Sep. 6, 2012

(54) DETECTING DEVICE AND PRINTER THAT DETECTS A REMAINING AMOUNT OF PAPER IN A PAPER ROLL

(75) Inventor: Kiyotaka Nihashi, Shizuoka (JP)

(73) Assignee: TOSHIBA TEC KABUSHIKI KAISHA, Tokyo (JP)

(21) Appl. No.: 13/407,956

(22) Filed: Feb. 29, 2012

(30) Foreign Application Priority Data
Mar. 3, 2011 (JP) 2011-46915

(51) Int. Cl. B41J 11/42; B65H 43/00

(52) U.S. Cl. 400/583; 242/563

(57) ABSTRACT

A paper roll remaining amount detecting device includes a paper roll receiving unit including first and second recesses to receive a paper roll with a cylindrical core dropping by its weight, depending on a printer mounting posture, when the paper roll is consumed to have a predetermined diameter. An attachment frame is pivotably supported on a sidewall of the paper roll receiving unit having an arc-shaped hole portion extending along a pivot movement trajectory of a pivoting end portion of the attachment frame. An arm is pivotably supported on the attachment frame, with a projection formed in a pivoting end portion thereof and inserted into the arc-shaped hole portion. When the paper roll becomes equal to or smaller than a predetermined size, the projection of the arm is moved toward the cylindrical core of the paper roll.

### CROSS-REFERENCE TO RELATED APPLICATION

This application is based upon and claims the benefit of priority from Japanese Patent Application No. 2011-046915, filed on Mar. 3, 2011, the entire contents of which are incorporated herein by reference.

### FIELD

Embodiments described herein relate generally to a remaining amount detecting device for use in, e.g., a Point of Sale (POS) printer, to detect a remaining amount of paper in a paper roll, and a printer.

### BACKGROUND

As a printer for use in a device, e.g., a POS terminal, there is a mounting-posture-selectable printer which can be mounted horizontally on a table or can be hung vertically on a wall surface.

This type of printer includes a hopper for receiving a paper roll. The hopper has a first recess for holding the paper roll when the printer is mounted horizontally, e.g., on a table and a second recess for holding the paper roll when the printer is mounted vertically, e.g., on a wall surface.

As the paper roll is consumed, the remaining amount of the paper roll held in the first recess or the second recess is reduced. A remaining amount detecting unit may be used to detect if the remaining amount of the paper roll is reduced to a specified amount or less, and to alert a user to replace the paper roll.

Conventionally, the attachment position of the remaining amount detecting unit needs to be changed depending on the posture of the printer, i.e., whether the printer is vertically mounted or horizontally mounted. However, the task of changing the attachment position of the remaining amount detecting unit is time-consuming and laborious.

In view of this, there is developed a printer in which the remaining amount of a paper roll can be detected by automatically changing the position of a remaining amount detecting unit depending on whether the printer is table-mounted or wall-hung.

In this conventional printer, however, the remaining amount detecting unit is provided in a hopper for receiving the paper roll and the position of the remaining amount detecting unit is changed by rotating the hopper as a whole. This poses a problem in that the printer becomes structurally complex and large-sized.

### BRIEF DESCRIPTION OF THE DRAWINGS

FIG. 1 is a side sectional view showing a printer mounted on a table.

FIG. 2 is a view illustrating a state in which the printer is hung on a wall surface.

FIG. 3 shows a state in which the paper roll is held within a first recess of a hopper as the paper is consumed.

FIG. 4 shows a state in which the paper roll is held within a second recess of a hopper as the paper is consumed.

FIG. 5 is a perspective view showing a remaining amount detecting device for detecting the remaining amount of the paper roll.

FIG. 6 is a side view of the remaining amount detecting device.

FIG. 7 is a front view of the remaining amount detecting device.

FIG. 8 shows a state in which the projection of the arm of the remaining amount detecting device is pressed against the end surface of the paper roll to thereby keep a detection sensor turned off.

FIG. 9 shows a state in which the projection of the arm of the remaining amount detecting device is moved into the cylindrical core of the paper roll to thereby turn the detection sensor on.

FIG. 10 is a view depicting the position the projection of the arm when the printer is hung on a wall surface.

### DETAILED DESCRIPTION

According to one embodiment, a paper roll remaining amount detecting device includes a paper roll receiving unit including a rest portion configured to support, depending on a printer mounting posture, an outer circumferential surface of a paper roll formed of a cylindrical core. The device further includes first and second recesses coupled to each other and formed in the rest portion, to receive the paper roll dropping by the weight of the roll paper if the paper roll is consumed to have a predetermined winding diameter. Further, the device includes an attachment frame pivotably supported on an outer surface of a sidewall of the roll paper receiving unit through a pivot shaft to pivot about the pivot shaft by the weight of the attachment frame, the sidewall of the paper roll receiving unit having an arc-shaped hole portion extending along a pivot movement trajectory of a pivoting end portion of the attachment frame; an arm pivot supported on the attachment frame, the arm including a projection formed in a pivoting end portion thereof and inserted into the arc-shaped hole portion of the sidewall of the paper roll receiving unit, the arm configured to operate such that, when the paper roll becomes equal to or smaller than a predetermined size by the consumption of the paper roll, the projection of the arm is moved into the cylindrical core of the paper roll. Further, the paper roll remaining amount detecting device includes a detecting unit configured to detect, based on the operation of the arm, whether the remaining amount of paper in the roll paper is equal to or smaller than the predetermined size.

Embodiments will now be described in detail with reference to the drawings.

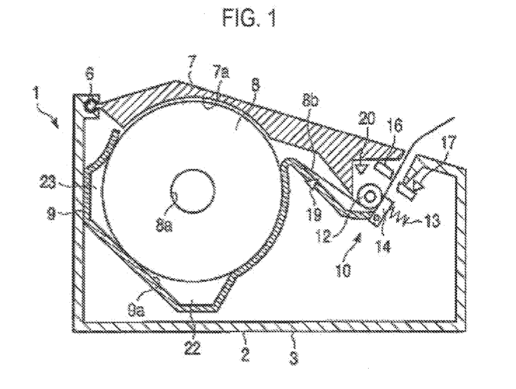

FIG. 1 is a side sectional view showing the internal structure of a printer according to one embodiment.

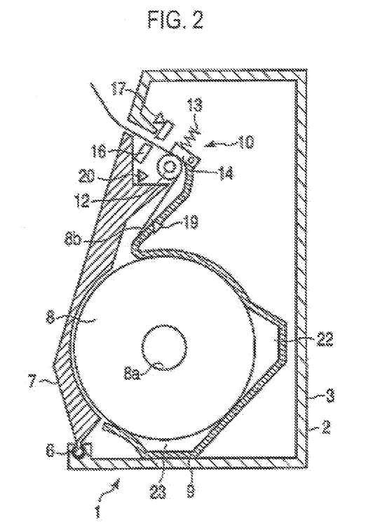

The printer is used for printing information on an elongated paper wound in a roll, and includes a printer body 1 whose orientation can be selected between a horizontal mounting position and a vertical mounting position. The printer body 1 may be mounted horizontally on a table or may be mounted vertically on a wall surface at the user's choice. FIG. 1 shows an instance where the printer body 1 is mounted on a table in the horizontal mounting position, and FIG. 2 shows an instance where the printer body 1 is hung on a wall surface in the vertical mounting position.

More specifically, a wide side 2 of the printer body 1 serves as an attachment portion 3 for mounting the printer body 1 on a desk in the horizontal mounting position or on a wall surface in the vertical mounting position.

The printer body 1 includes a cover 7 that is rotatably supported by a hinge 6, such that the cover 7 can be opened and closed about the hinge 6. A hopper 9, as a paper roll receiving unit for receiving a paper roll 8, and a printing unit 10 are arranged within the printer body 1. The paper roll 8 includes cylindrical core 8a and an elongated thermal paper 8b wound around the core 8a in a roll. An arc-shaped concave surface 7a is formed in the cover 7 to have room to accommodate the paper roll 8 having a maximum winding diameter.

The printing unit 10 includes a platen 12 rotated by a platen motor and a thermal head 14 pressed against the platen 12 by the biasing force of a head spring 13.

At the downstream side of the printing unit 10, there are provided a cutter 16 driven by a cutter motor and a cutter home position sensor 17 configured to detect the home position of the cutter 16.

At the upstream side of the printing unit 10, a paper end sensor 19 is arranged between the hopper 9 and the platen 12 to detect the presence and absence of paper.

A cover sensor 20 configured to detect the opening and closing of the cover 7 is provided above the platen 12.

The hopper 9 includes a rest portion 9a configured to support the outer circumferential surface of the paper roll 8.

As shown in FIG. 1, the rest portion 9a supports the outer circumferential surface of the paper roll 8 against the weight of the paper roll 8, either when the printer body 1 is mounted on a table in the horizontal mounting posture with the attachment portion 3 kept horizontal or when the printer body 1 is hung on wall surface with the attachment portion 3 kept vertical.

A first recess 22 and a second recess 23 are formed in the rest portion 9a so that the first recess 22 is coupled to the second recess 23. If the thermal paper 8b is consumed to such an extent that the winding diameter of the paper roll 8 becomes equal to or smaller than a specified value, the paper roll 8 is dropped by the weight thereof and received within one of the first recess 22 and the second recess 23 depending on the mounting position of the printer 1.

In the configuration stated above, during a printing process, the thermal paper 8b is withdrawn by the rotation of the platen 12 and print information is printed on the thermal paper 8b by the thermal head 14. When the printed thermal paper 8b is withdrawn by a predetermined distance, the printed thermal paper 8b is cut by the cutter 16 and discharged outside of the printer 1.

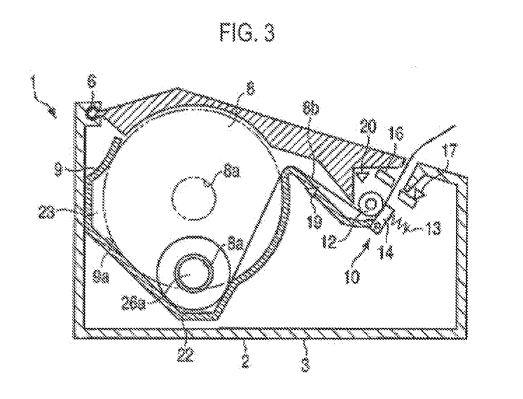

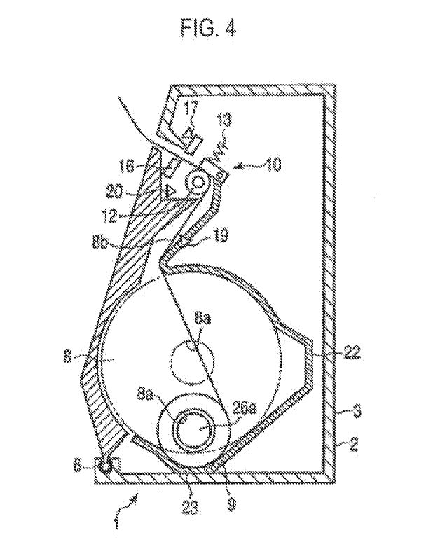

As the thermal paper 8b is consumed by this printing operation, the winding diameter of the paper roll 8 becomes smaller. When the printer body 1 is mounted on a table in the horizontal mounting position, the paper roll 8 is received within the first recess 22 of the hopper 9 as illustrated in FIG. 3. On the other hand, when the printer body 1 is wall-hung, the paper roll 8 is received within the second recess 23 of the hopper 9 as illustrated in FIG. 4.

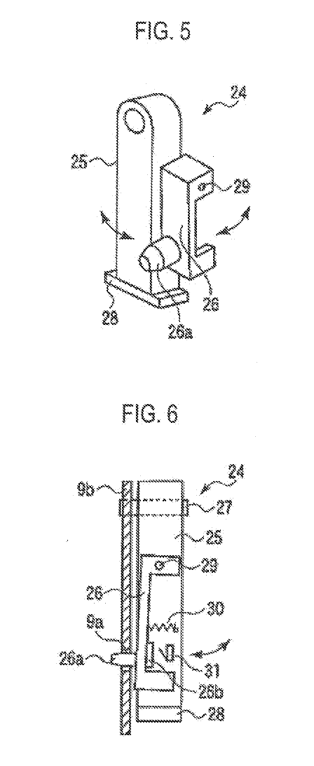

A remaining amount of paper detecting device 24 (see in FIG. 5) configured to detect the remaining amount of paper in the paper roll 8 is provided inside the printer body 1.

As shown in FIG. 6, the remaining amount of paper detecting device 24 is arranged at the outer surface side of an end plate 9b serving as a sidewall of the hopper 9 in opposing relationship with the end plate 9b. The remaining amount detecting device 24 is provided with an attachment frame 25 as an attachment member. An upper end portion of the attachment frame 25 is pivotably supported on the end plate 9b of the hopper 9 through a pivot shaft 27. A weight body 28 is provided in a lower end portion of the attachment frame 25. The attachment frame 25 pivots up and down about the pivot shaft 27 by the weight of the weight body 28.

An arm 26 is provided on one side surface of the attachment frame 25. An upper end portion of the arm 26 is pivotably supported on the one side surface of the attachment frame 25 through a pivot pin 29. A projection 26a protrudes from a lower end portion of the arm 26. A lug 26b protrudes from the surface of the arm 26 opposite to the surface having the projection 26a. The arm 26 is biased by a spring 30 as a biasing member to swing toward the end plate 9b of the hopper 9 so that the projection 26a can be inserted into a slot 9c as a hole portion formed in the end plate 9b of the hopper 9.

On the one side surface of the attachment frame 25, a detection sensor 31 as a detecting unit is arranged to face the lug 26b of the arm 26. As the arm 26 pivots, the detection sensor 31 is configured to turn on by being pressed by the lug 26b or turned off by being released from the lug 26b.

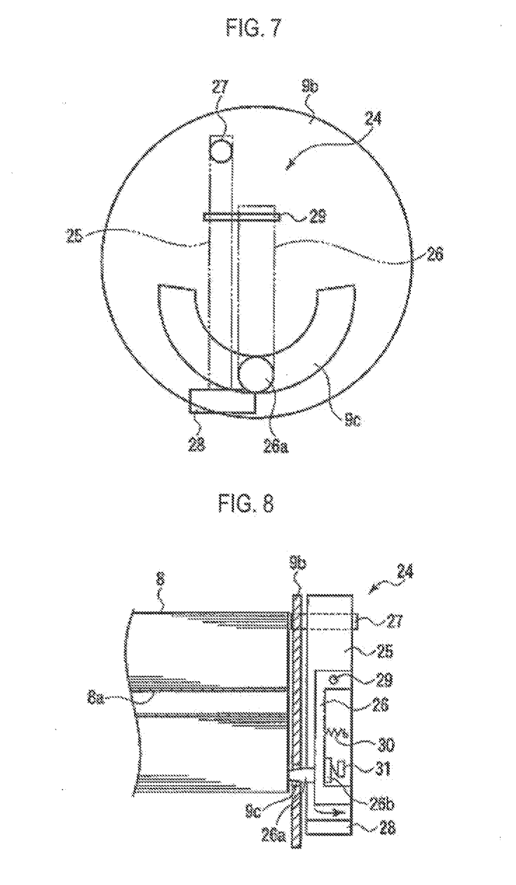

As shown in FIG. 7, the slot 9c of the end plate 9b of the hopper 9 is formed into an arc shape along the rotation trajectory of the lug 26b of the arm 26.

Depending on the mounting position of the printer, the attachment frame 25 pivots about the pivot shaft 27. By this pivot movement, the lug 26b of the arm 26 moves along the slot 9c of the end plate 9b to a position where the lug 26b is aligned with the cylindrical core 8a of the paper roll 8 whose remaining amount is reduced to a predetermined amount or less by the consumption of paper.

The following is a description on the operation of detecting the remaining amount of paper in the paper roll 8.

If the printer is mounted on a table without loading the paper roll 8 in the printer, the attachment frame 25 of the remaining amount of paper detecting device 24 pivots to be vertically positioned by the weight of the weight body 28 as shown in FIGS. 6 and 7. If the paper roll 8 is loaded in this condition as shown in FIG. 8, the end surface of the paper roll 8 comes into contact with the projection 26a of the arm 26. Thus, the arm 26 moves away from the end surface of the paper roll 8 against the biasing force of the spring 30 as indicated by an arrow. As a result of this movement, the detection sensor 31 is pressed by the lug 26b of the arm 26 and is turned off.

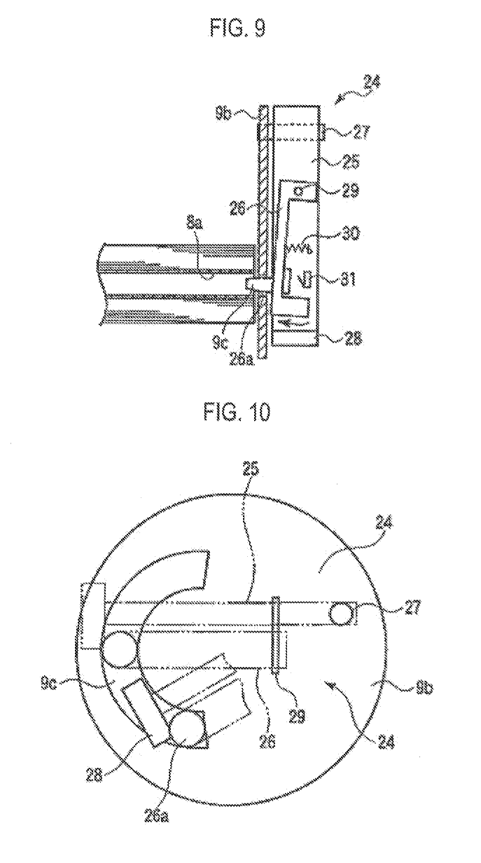

A printing operation is performed in the above configuration. As the paper roll 8 is consumed, the winding diameter of the paper roll 8 becomes smaller. Thus, the paper roll 8 is received within the first recess 22 of the hopper 9. If the paper roll 8 is further consumed in this state and if the remaining amount of paper in the paper roll 8 becomes equal to or smaller than a predetermined amount, the projection 26a of the arm 26 is aligned with the cylindrical core 8a of the paper roll 8 and the arm 26 is rotated in a direction indicted by an arrow shown in FIG. 9 by the biasing force of the spring 30, thereby allowing the projection 26a to move into the cylindrical core 8a of the paper roll 8. Consequently, the lug 26b of the arm 26 is separated from the detection sensor 31 whereby the detection sensor 31 is released from the lug 26b and turned on. By detecting that the detection sensor 31 is turned on, it is determined that the remaining amount of paper in the paper roll 8 is reduced to the predetermined amount or less. Such detection result may be displayed on a display unit, alerting an operator to replace the paper roll 8 with a new paper roll.

When the printer is hung on a wall, the posture of the printer is changed 90 degrees as shown in FIG. 2. Prior to loading the paper roll 8, as shown in FIG. 10, the attachment frame 25 of the remaining amount of paper detecting device 24 pivots down about the pivot shaft 27 by the weight of the weight body 28. By this pivot movement, the projection 26a of the arm 26 may be shifted along the slot 9c of the end plate 9b of the hopper 9. After moving a specified distance, the projection 26a of the arm 26 stops by making contact with the inner surface of one end of the slot 9c.

If the paper roll 8 is loaded in this condition, the projection 26a of the arm 26 comes into contact with the end surface of the paper roll 8 as set forth above with reference to FIG. 8. The arm 26 moves away from the end surface of the paper roll 8 against the biasing force of the spring 30. As a result of this movement, the detection sensor 31 is pressed by the lug 26b of the arm 26 and is turned off.

A printing operation is performed in the above configuration. As the paper roll 8 is consumed, the winding diameter of the paper roll 8 becomes smaller. Thus, the paper roll 8 is received within the second recess 23 of the hopper 9. If the paper roll 8 is further consumed in this state and if the remaining amount of paper in the paper roll 8 becomes equal to or smaller than a predetermined amount, the projection 26a of the arm 26 is aligned with the cylindrical core 8a of the paper roll 8. Thus, the arm 26 is rotated in the arrow direction by the biasing force of the spring 30 as stated above with reference to FIG. 9, thereby allowing the projection 26a to move into the cylindrical core 8a of the paper roll 8. Consequently, the lug 26b of the arm 26 is separated from the detection sensor 31 whereby the detection sensor 31 is released from the lug 26b and turned on. By detecting that the detection sensor 31 is turned on, it is determined that the remaining amount of paper in the paper roll 8 is reduced to a predetermined amount or less is detected and a request for replacement of the paper roll 8 is displayed on a display unit (not shown).

According to the present embodiment described above, the remaining amount of paper detecting device 24 is pivotably installed in the hopper 9 for receiving the paper roll 8 and the detection position is changed by the pivot movement of the remaining amount of paper detecting device 24 by its weight depending on the mounting position of the printer. Accordingly, the remaining amount of paper in the paper roll 8 can be detected without having to rotate the hopper 9 as a whole and regardless of whether the printer is horizontally mounted or vertically mounted. This assists in making the printer structurally simple.

According to the present embodiment, even if the printer is mounted on a tilted table, the detection position can be changed and the remaining amount of paper in the paper roll 8 can be detected by allowing the remaining amount of paper detecting device 24 to pivot in conformity with the inclination of the table.

While certain embodiments have been described, these embodiments have been presented by way of example only, and are not intended to limit the scope of the inventions. Indeed, the novel device and printer described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A paper roll remaining amount detecting device, the device comprising:
a paper roll receiving unit including a rest portion configured to support, depending on a printer mounting posture, an outer circumferential surface of a paper roll formed of a cylindrical core and first and second recesses formed in the rest portion to receive the paper roll dropping by the weight of the paper roll when the paper roll is consumed to have a predetermined winding diameter;
an attachment frame pivotably supported on an outer surface of a sidewall of the paper roll receiving unit through a pivot shaft to pivot about the pivot shaft by the weight of the attachment frame, the sidewall of the paper roll receiving unit having an arc-shaped hole portion extending along a pivot movement trajectory of a pivoting end portion of the attachment frame;
an arm pivotably supported on the attachment frame, the arm including a projection formed in a pivoting end portion thereof and inserted into the arc-shaped hole portion of the sidewall of the paper roll receiving unit, the arm configured to operate such that, when the paper roll becomes equal to or smaller than a predetermined size by the consumption of the paper roll, the projection of the arm is moved toward the cylindrical core of the paper roll; and
a detecting unit configured to detect, based on the operation of the arm, whether the paper roll is equal to or smaller than the predetermined size.

2. The device of claim 1, further comprising:
a biasing member configured to elastically bias the arm to pivot toward an end surface of the paper roll.

3. The device of claim 2, wherein the detecting unit comprises a sensor configured to be turned on and off as the projection of the arm is moved toward and away from the end surface of the paper roll.

4. A printer, comprising:
a printer body including an attachment portion configured to be selectively attached to one of a vertical surface and a horizontal surface depending on a mounting posture of the printer body;
a printing unit provided within the printer body;
a paper roll receiving unit including a rest portion configured to support, depending on the mounting posture of the printer body, an outer circumferential surface of a paper roll formed of a cylindrical core and first and second recesses formed in the rest portion to receive the paper roll dropping by the weight of the paper roll when the paper roll is consumed to have a predetermined winding diameter;
an attachment frame pivotably supported on an outer surface of a sidewall of the paper roll receiving unit through a pivot shaft to pivot about the pivot shaft by the weight of the attachment frame, the sidewall of the paper roll receiving unit having an arc-shaped hole portion extending along a pivot movement trajectory of a pivoting end portion of the attachment frame;
an arm pivotably supported on the attachment frame, the arm including a projection formed in a pivoting end portion thereof and inserted into the arc-shaped hole portion of the sidewall of the paper roll receiving unit, the arm configured to operate such that, when the paper roll becomes equal to or smaller than a predetermined size by the consumption of the paper roll, the projection of the arm is moved toward the cylindrical core of the paper roll; and
a detecting unit configured to detect, based on the operation of the arm, whether the remaining amount of paper in the paper roll is equal to or smaller than the predetermined size.

5. The printer of claim 4, further comprising:
a biasing member configured to elastically bias the arm to pivot toward an end surface of the paper roll.

6. The printer of claim 5, wherein the detecting unit comprises a sensor configured to be turned on and off as the projection of the arm is moved toward and away from the end surface of the paper roll.
